(19) United States
(12) Patent Application Publication
(10) Pub. No.: US 2019/0020269 A1
(43) Pub. Date: Jan. 17, 2019

(54) RESONANT POWER CONVERTER WITH DEAD-TIME CONTROL OF SYNCHRONOUS RECTIFICATION CIRCUIT

(71) Applicant: Danmarks Tekniske Universitet, Kgs. Lyngby (DK)

(72) Inventors: Marzieh Ekhtiari, Frederiksberg (DK); Tiberiu-Gabriel Zsurzsan, Kgs. Lyngby (DK); Michael Andreas Esbern Andersen, Helsinge (DK)

(21) Appl. No.: 16/069,024

(22) PCT Filed: Jan. 10, 2017
(86) PCT No.: PCT/EP2017/050395

§ 371 Date: Jul. 10, 2018

(30) Foreign Application Priority Data
Jan. 12, 2016 (EP) 16150905.4

(51) Int. Cl. H02M 1/38; H02M 3/335

(52) U.S. Cl. CPC H02M 1/38; H02M 3/33592; H02M 3/33584

(57) ABSTRACT

A resonant power converter including a synchronous rectifier for supplying a DC output voltage. The synchronous rectifier is configured for alternatingly connecting a resonant output voltage to positive and negative DC output nodes via first and second semiconductor switches, respectively, separated by intervening dead-time periods in accordance with first and second rectification control signals. A dead-time controller is coupled to the resonant output voltage or the resonant input voltage and configured for adaptively adjusting lengths of the dead-time periods via the first and second rectification control signals.

The invention relates in a first aspect to a resonant power converter comprising a synchronous rectifier for supplying a DC output voltage. The synchronous rectifier is configured for alternatingly connecting a resonant output voltage to positive and negative DC output nodes via first and second semiconductor switches, respectively, separated by intervening dead-time periods in accordance with first and second rectification control signals. A dead-time controller is coupled to the resonant output voltage or the resonant input voltage and configured for adaptively adjusting lengths of the dead-time periods via the first and second rectification control signals.

### BACKGROUND OF THE INVENTION

A sub-group of resonant power converter comprises a piezoelectric transformer as a resonant circuit or resonant tank. Piezoelectric power converters are a viable alternative to traditional magnetics based resonant power converters in numerous voltage or power converting applications such as AC/AC, AC/DC, DC/AC and DC/DC power converter applications. Piezoelectric power converters are capable of providing high isolation voltages and high power conversion efficiencies in a compact package with low EMI radiation. The piezoelectric transformer is normally operated in a narrow frequency band around its fundamental or primary resonance frequency with a matched load coupled to the output of the piezoelectric transformer. The optimum switching frequency or excitation frequency of the piezoelectric power converter shows strong dependence on different parameter such as temperature, load, fixation and age. So-called zero-voltage-switching (ZVS) operation, or soft-switching, of an input driver and/or a synchronous rectification circuit of the piezoelectric power converter is important to avoid prohibitive power losses associated with the respective switching activities of the input driver and/or synchronous rectification circuit. However, synchronous rectification circuits of prior art resonant power converters have utilized a fixed length of the dead-time period, for example tailored to characteristics of a particular piezoelectric transformer at fixed operating conditions. The fixed dead-time period is unable to account for manufacturing tolerances and drift of active and passive electronic components of the resonant power converter, in particular those of a piezoelectric transformer.

Hence, the use of fixed dead-time periods leads to increased power consumption of practical resonant power converters where the above-mentioned manufacturing tolerances and drift of active and passive electronic components are inevitable. Hence, it would be advantageous to provide mechanisms for maintaining the desired zero voltage switching (ZVS) properties of the input driver and/or synchronous rectification circuit.

US 2015/0229219 A1 discloses a magnetics based (LC) resonant power converter comprising a half-bridge input driver connected to a primary side of a transformer for generating a resonant input voltage. The resonant power converter further comprises a synchronous rectification circuit comprising MOSFET switches SR1 and SR2. The gates of SR1 and SR2 are controlled by respective gate drive signals SRDRV1 and SRDRV2 which are derived, by a predictive gate drive circuit, from corresponding gate drive signals PROUT1, PROUT2 of switches of the half-bridge input driver. Hence, locking the switching timing and switching frequency of the rectification circuit to the switching timing and switching frequency of the input driver.

### SUMMARY OF THE INVENTION

A first aspect of the invention relates to a resonant power converter comprising:

a first power supply rail for receipt of a positive DC supply voltage and a second power supply rail for receipt of a negative DC supply voltage,
a resonant network comprising an input section for receipt of a resonant input voltage and an output section for supplying a resonant output voltage generated in response to the resonant input voltage,
an input driver configured for supplying the resonant input voltage;
a synchronous rectifier comprising:
a rectifier input coupled to the resonant output voltage,
first and second semiconductor switches controlled by first and second rectification control signals, wherein the synchronous rectifier is configured for alternatingly connecting the resonant output voltage to positive and negative DC output nodes via the first and second semiconductor switches, respectively, separated by intervening dead-time periods in accordance with the first and second rectification control signals;
a first dead-time controller coupled to the resonant output voltage or the resonant input voltage and configured for adaptively adjusting lengths of the dead-time periods via the first and second rectification control signals.

The first dead-time controller is configured to provide adequate length or duration of the dead time periods of the synchronous rectifier to deliver sufficient energy for charging and discharging various capacitances at the output section of the resonant network with the resonant current alternatingly flowing into and out of the resonant network. The capacitances at the output section of the resonant network may comprise a capacitance of a secondary section of a piezoelectric transformer and various intrinsic capacitances of the first and second semiconductor switches.

The first dead-time controller is able to maintain zero voltage switching (ZVS) and/or zero current switching (ZCS) of the synchronous rectifier despite temperature drift and variation of component values or parameters of the resonant power converter by adaptively adjusting lengths or durations of the dead-time periods of the synchronous rectifier. Maintaining proper ZVS operation over time minimizes energy consumption involved in the switching activity of the first and second semiconductor switches of the synchronous rectifier. The present inventors have discovered that a dead-time period shorter than required for zero voltage switching causes hard switching of the synchronous rectifier. Likewise, a dead-time period longer than required for zero voltage switching may either cause hard switching of the synchronous rectifier or may cause soft switching of the synchronous rectifier with sub-optimum efficiency. The synchronous rectifier may comprise a half-wave rectifier or a full-wave rectifier.

The resonant power converter may comprise an AC-DC or DC-DC converter topology. The positive and negative DC output nodes of the synchronous rectifier may provide the DC output voltage of the resonant power converter for connecting to a load device, load resistor or load circuit.

The first dead-time controller of the resonant power converter may utilize various features of the resonant output voltage for detecting an optimum length of the dead time period and adaptively adjusting the length of the dead-time period. The dead-time controller may be configured to adjust the length of the dead-time period during every switching cycle of the resonant output voltage based on an instantaneous value thereof. Alternatively, the dead-time controller may be configured to adjust the lengths of dead-time periods during a specific operating condition of the resonant power converter—for example solely during a start-up or initialization phase of the resonant network or solely during steady state operation of the resonant network.

The switching cycle is determined by a selected switching frequency of the resonant power converter. The switching frequency of the resonant power converter may be set by certain characteristics or tuning of one or two self-oscillating feedback loops connected around a secondary side circuit and/or around a primary side circuit of the resonant power converter as discussed in further detail below with reference to the appended drawings.

The synchronous rectifier may comprise a half-bridge or H-bridge driver. The half-bridge driver circuit may comprise a first semiconductor switch and a second semiconductor switch coupled in series between the positive DC supply voltage and the negative DC supply voltage. A midpoint node between the first and second semiconductor switches may be connected to an input of the synchronous rectifier. Hence, according to one embodiment of the resonant power converter, the first semiconductor switch comprises a conducting state connecting the resonant output voltage to the positive DC supply voltage and the second semiconductor switch comprises a conducting state connecting the resonant output voltage to the negative DC supply voltage. In addition, each of the first and the second semiconductor switches resides in a non-conducting or off state during the dead-time periods of the rectification circuit.

According one embodiment of the present resonant power converter, the input driver comprises third and fourth semiconductor switches controlled by first and second driver control signals, respectively. The input driver is configured for alternatingly connecting the resonant input voltage to the positive and negative DC supply voltages through the third and fourth semiconductor switches, respectively, separated by intervening dead-time periods in accordance with the first and second driver control signals. The first driver control signal is configured to switch the third semiconductor switch between a conducting/ON state and a non-conducting/OFF state. The second driver control signal is likewise configured to switch the fourth semiconductor switch between a conducting/ON state and a non-conducting/OFF state. The first and second driver control signals are preferably non-overlapping such that the third semiconductor switch pulls the resonant input voltage towards the positive DC supply voltage via its relatively small on-resistance in the conducting state and the fourth semiconductor switch, subsequent to the intervening dead-time period, pulls the resonant input voltage towards the negative DC supply voltage via its relatively small on-resistance in the conducting state. Hence, during the dead time period of the input driver the resonant input voltage or signal is alternatingly charged and discharged from the positive DC supply voltage to the negative DC supply voltage and vice versa by resonant current flowing through an intrinsic input impedance of the piezoelectric transformer and/or by resonant current flowing through, or out of, a series inductor of the resonant network as discussed in further detail below with reference to the appended drawings. The resonant input signal is effectively clamped to the positive DC supply voltage in a first time period where the third semiconductor switch conducts and the fourth semiconductor switch is non-conducting. Likewise, the resonant input signal is clamped to the negative DC supply voltage in a second time period where the fourth semiconductor switch is conducting and the third semiconductor switch is non-conducting. During the dead-time periods, both the third semiconductor switch and the fourth semiconductor switch are non-conducting.

Each of the first, second, third and fourth semiconductor switches may comprise a MOSFET for example a DMOS, PMOS or NMOS device. Each of the first, second, third and fourth semiconductor switches further comprises a control terminal or input such as a gate terminal for receipt of the respective driver control signal or rectification control signal.

As discussed previously, the resonant network may comprise a piezoelectric transformer wherein the input section of the resonant network comprises a primary section of the piezoelectric transformer coupled to the resonant input voltage and the output section of the resonant network comprises a secondary section of the piezoelectric transformer for generating the resonant output voltage.

The switching frequency of the resonant power converter may lie between 75 kHz and 500 kHz such as between 100 kHz and 150 kHz. The resonant power converter may comprise a feedback loop configured to induce self-oscillation around the primary side circuit and/or secondary side circuit of the resonant power converter as discussed in additional detail below. The feedback loop may ensure that a switching frequency of the resonant power converter automatically tracks changing characteristics of the resonant network, e.gl based on a piezoelectric transformer, and electronic circuitry of the primary side or secondary side of the power converter.

According to one embodiment, the dead-time controller utilizes a level or amplitude of the resonant input voltage to detect the respective time instant to switch the first or the second semiconductor switch to its conducting state. According to another embodiment, the dead-time controller utilizes a waveform shape of the instantaneous resonant input voltage to detect the respective time instants or phases at which to switch the first or second semiconductor to their respective conducting states as discussed in further detail below with reference to the appended drawings.

The dead-time controller may be configured to adjust a phase or a timing of the first driver control signal of the first semiconductor switch and a phase or timing of the second driver control signal of the second semiconductor switch to adaptively adjust the duration of the dead-time periods as discussed in further detail below with reference to the appended drawings.

According to one embodiment of the resonant power converter, the first and second rectification control signals are derived from the resonant output voltage or a resonant output current of the output section of the resonant circuit. One advantage of this embodiment is that the timing or phase of the first and second rectification control signals of the secondary side circuit of the resonant power converter is independent of the timing of the switching of the input driver at the primary side circuit of the resonant power converter. This feature typically ensures an optimum operating point of the secondary side circuit of the resonant power converter as discussed in further detail below with reference to the appended drawings.

According to one embodiment, the first and second driver control signals of the input driver are derived from the resonant input voltage or a resonant input current of the input section of the resonant circuit. According to the latter embodiment, the timing or phase of the switching of the input driver, e.g. the switching of the third and fourth semiconductor switches via the first and second driver control signals, is independent of the timing of the switching of the first and second rectification control signals of the secondary side circuit of the resonant power converter. This feature typically ensures an optimum operating point of the primary side circuit of the resonant power converter.

A number of useful embodiments of the present resonant power converter exploit the above-discussed resonant output voltage or the resonant output current to form a first self-oscillating loop around the secondary side circuit of the resonant power converter. Another set of useful embodiments of the present resonant power converter exploits the above-discussed resonant input voltage or the resonant input current to form a second self-oscillating loop around the primary side circuit of the resonant power converter. The primary side and secondary side self-oscillating feedback loops are efficient for setting or controlling the respective switching frequencies of the primary side and secondary side of the resonant power converter in an optimum manner. Hence, maintaining optimum operating points of the primary side and secondary side of the resonant power converter during operation despite drift or variation of component values and parameters of the power converter—for example those caused by ageing and temperature variations. Each of the first and second self-oscillating loops may be designed or configured to oscillate at, or proximate to, a fundamental resonance frequency of the input section or output section of the resonant network, respectively, as discussed in further detail below with reference to the appended drawings.

The first dead-time controller may be coupled to the resonant output voltage in one embodiment of the resonant power converter. The previously discussed first self-oscillating feedback loop may comprise a first resonant voltage or current detector coupled to the output section of the resonant circuit and configured to derive a first feedback signal from the resonant voltage or resonant current of the output section. The resonant power converter further comprises a first adjustable delay circuit configured for generating the first and second rectification control signals based on the first feedback signal. The piezoelectric transformer may comprise a separate electrode for supplying the first resonant voltage or current detector with a resonant voltage or current proportional to the resonant output voltage. Hence, the piezoelectric transformer may comprise:
a first secondary electrode connected to the secondary section of the piezoelectric transformer for supplying the resonant output voltage; and
a second secondary electrode embedded in the secondary section for supplying the first feedback signal to the first adjustable delay circuit.

One embodiment of the resonant power converter comprises a first phase shift circuit configured to derive the first and second drive control signals from the first and second rectification control signals by adding respective phase shifts to the first and second rectification control signals. This feature is advantageous in certain applications because the first and second drive control signals are derived/generated in a relatively simple manner from the first and second rectification control signals, respectively, using a small amount of additional components and signal routing as discussed in further detail below with reference to the appended drawings.

In an alternative embodiment, the first dead-time controller is coupled to the resonant input voltage and a self-oscillating feedback loop is connected around the primary section of the power converter. The self-oscillating feedback loop comprises a resonant voltage or current detector coupled to the input section of the resonant circuit and configured to derive a first feedback signal from a resonant voltage or resonant current of the input section; The self-oscillating feedback loop further comprises a first adjustable delay circuit configured for generating the first and second drive control signals based on the first feedback signal. In some of these embodiments, the resonant network comprises a piezoelectric transformer which comprises:
a first primary electrode connected to the primary section of the piezoelectric transformer for supplying the resonant input voltage; and
a second primary electrode embedded in the primary section of the piezoelectric transformer for supplying the first feedback signal to the first adjustable delay circuit. One such embodiment comprises a first phase shift circuit configured to derive the first and second drive control signals from the first and second rectification control signals by adding respective phase shifts to the first and second rectification control signals as discussed in further detail below with reference to the appended drawings.

Another alternative embodiment of the resonant power converter comprises two separate and independent self-oscillating feedback loops connected around the primary section or the secondary section, respectively, of the power converter as discussed above. The presence of such separate self-oscillating feedback loops in the present piezoelectric resonant power converter provides numerous advantages such as an adjustable bi-directional power flow between the DC input voltage and the DC output voltage. The characteristics of this bi-directional power flow can furthermore be very accurately and flexibly controlled by independent digital control or setting of the respective time delays of the first and second adjustable delay circuits as discussed in further detail below with reference to the appended drawings.

One such embodiment of the resonant power converter therefore comprises, in addition to the first self-oscillating feedback loop:
the second self-oscillating feedback loop comprising:
   a second resonant voltage or current detector coupled to the input section of the resonant circuit and configured to derive a second feedback signal from a resonant voltage or resonant current of the input section; and a second adjustable delay circuit configured for generating the first and second drive control signals based on the second feedback signal; and
a second dead-time controller coupled to the resonant input voltage and configured for adaptively adjusting lengths of the dead-time periods of the input driver via the first and second driver control signals. The first adjustable delay circuit may comprise a first digital delay line and a first digital control input for adjusting respective time delays between the first feedback signal and the first and second rectification control signals. The second adjustable time delay circuit may in addition or alternative comprise a second digital delay line and a second digital control input for adjusting respective time delays between the second feedback signal and the first and second driver control signals. Various construction details, programming interfaces etc. of the first and second digital delay lines are discussed in further detail below with reference to the appended drawings.

Each of the first and second adjustable time delay circuits may comprise a digital control input for setting the time delay in the digital domain by a digital processor such as a microprocessor. For this purpose the resonant power converter may therefore comprise:

a digital processor comprising a first data communication interface connected to at least one of the first and second digital control inputs of the first and second adjustable time delay circuits;
said digital processor being configured to repeatedly compute and apply time delay settings for at least one of:
the first digital delay line for adapting a switching frequency of the first self-oscillating feedback loop to a fundamental resonance frequency of the output section of the resonant circuit; and
the second digital delay line for adapting a switching frequency of the second self-oscillating feedback loop to a fundamental resonance frequency of the input section of the resonant circuit.

The digital processor is configured to:

compute the time delay settings of the first digital delay line to maintain a loop phase shift of substantially 360 degrees, or an integer multiple of 360 degrees, in the first self-oscillating feedback loop; and/or
compute the time delay settings of the second digital delay line to maintain a loop phase shift of substantially 360 degrees, or an integer multiple of 360 degrees, in the second self-oscillating feedback loop.

One embodiment of the first and/or second adjustable time delay circuits has a time step resolution of the first or second digital delay line greater than 10 ns such as greater than 2 ns, or greater than 1 ns, as discussed in further detail below with reference to the appended drawings.

The first dead-time controller may be configured to adjust a phase of the first rectification control signal based on a waveform shape of the resonant output or input voltage and a phase of the second rectification control signal based on the waveform shape of the resonant output or input voltage to adaptively adjust the lengths of the dead-time periods.

A second aspect of the invention relates to a method of adaptively controlling dead-time periods of a synchronous rectifier of a resonant power converter, said method comprising steps of:

a) deriving first and second non-overlapping rectification control signals of the synchronous rectifier from a resonant output voltage or from a resonant input voltage of a resonant network of the resonant power converter, wherein the synchronous rectifier is coupled between positive and negative DC output voltage nodes of the converter,
b) applying the first and second non-overlapping rectification control signals to control inputs of the synchronous rectifier to generate a DC output voltage by alternatingly connecting the resonant output voltage to the positive and negative DC output voltage nodes separated by intervening dead-time periods,
c) monitoring at least one of the resonant output voltage and the resonant input voltage,
d) detecting a feature or characteristic of a waveform of the resonant output voltage or the resonant input voltage,
f) adjusting lengths of the dead-time periods of the synchronous rectifier based on the detected feature.

According to one embodiment of the present methodology of adaptively controlling dead-time periods, step d) may comprise:

detecting the feature of the waveform in each cycle of the resonant input voltage waveform or detecting the feature of the waveform in each cycle of the resonant output voltage waveform.

### BRIEF DESCRIPTION OF THE DRAWINGS

Preferred embodiments of the invention are described in more detail in connection with the appended drawings, in which:

FIG. 1 shows a simplified schematic circuit diagram of a piezoelectric resonant power converter in accordance with a first embodiment of the invention,

FIG. 2 shows a simplified schematic circuit diagram of an exemplary adjustable delay circuit for application in various embodiments of the present piezoelectric resonant power converters,

FIG. 2A shows a schematic circuit diagram of an exemplary embodiment of the adjustable delay circuit of FIG. 2 based on a digital delay line for application in various embodiments of the present piezoelectric resonant power converters,

FIG. 3 shows a simplified schematic circuit diagram of a piezoelectric resonant power converter in accordance with a second embodiment of the invention,

FIG. 4 shows a schematic block diagram of an exemplary dead-time controller for use in resonant power converters in accordance with various embodiments of the present invention; and

FIG. 5 is a simplified schematic circuit diagram of a piezoelectric resonant power converter in accordance with a third embodiment of the invention.

### DETAILED DESCRIPTION OF PREFERRED EMBODIMENTS

In the following sections various exemplary embodiments of the present resonant power converter are described with reference to the appended drawings. The skilled person will understand that the accompanying drawings are schematic and simplified for clarity and therefore merely show details which are essential to the understanding of the invention, while other details have been left out. Like reference numerals refer to like elements throughout. Like elements will, thus, not necessarily be described in detail with respect to each figure.

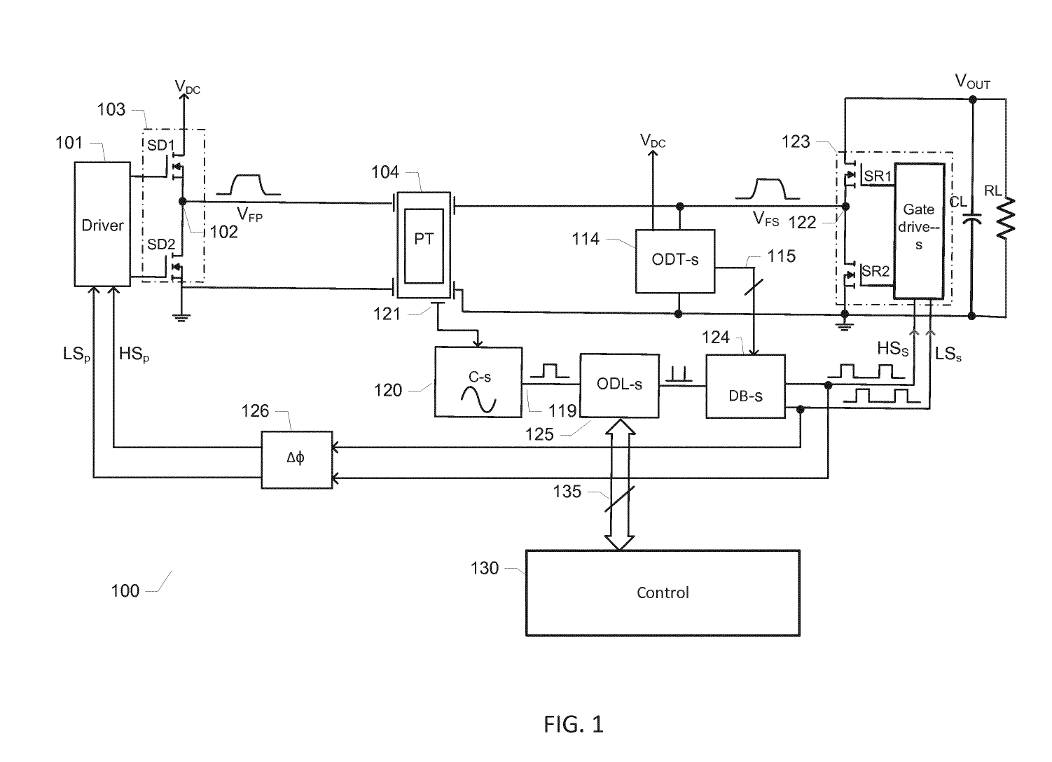

FIG. 1 shows a simplified schematic block diagram of a resonant power converter 100 based on a piezoelectric transformer 104 operating as a resonant network of the power converter. The piezoelectric resonant power converter 100 comprises an input driver 103 electrically coupled to an input section or primary section of the piezoelectric transformer 104 for receipt of a resonant input voltage V_{FP}. The resonant input voltage V_{FP} is supplied at an output node or terminal 102 of the input driver 103. Hence, the resonant input voltage V_{FP} is an ac input drive signal with a frequency corresponding to a switching frequency of the power converter 100. The resonant input voltage V_{FP} may be applied to the input or primary section of the piezoelectric transformer 104 via first and second physical input electrodes of the transformer 104. A driver control circuit 101 is configured to generate appropriately timed gate control signals for the first and second semiconductor switches S_{D1} and S_{D2} of the input driver 103. Each of the first and second semiconductor switches S_{D1} and S_{D2} may comprise a FET for example a NMOS or PMOS transistor. The first and second semiconductor switches S_{D1} and S_{D2} are coupled in cascade such that they jointly form a half-bridge topology of the input driver 103. The second input electrode of the piezoelectric transformer 104 may be connected to a negative DC supply rail of the power converter 100 such as ground, GND, shared with the input driver 103 as illustrated. The input driver 103 additionally comprises a first power supply rail for receipt of a positive DC supply voltage V_{DD}. Hence, the waveform of the resonant input voltage V_{FP} is determined by a first driver control signal LS_{P} and a second driver control signal HS_{P} supplied to the first and second semiconductor switches S_{D1} and S_{D2} through the driver control circuit 101. The first and second input control signals LS_{P}, HS_{P} are derived via time delay or phase shift imparted by an optional phase shifter 126 coupled to first and second rectification control signals LS_{S}, HS_{S} of a synchronous rectifier 123 of a secondary side circuit of the resonant power converter 100 as discussed below in further detail. The first and second driver signals LS_{P}, HS_{P} are non-overlapping and separated by intervening off periods as discussed below in further detail.

The above-mentioned secondary side circuit of the piezoelectric resonant power converter 100 comprises an output section of the piezoelectric transformer 104, the synchronous rectifier 123, a smoothing capacitor C_{L} and a converter load R_{L} connected to a DC output voltage V_{OUT} of the piezoelectric power converter. The output section of the piezoelectric transformer 104 generates the resonant output voltage V_{FS} at an output electrode or electrodes coupled to the secondary section of the piezoelectric transformer 104 in response to the previously discussed application of the resonant input voltage V_{FP} to the primary section of the piezoelectric transformer 104. The resonant output voltage V_{FS} is applied to an input node 122 of the synchronous rectifier 123. The synchronous rectifier 123 comprises first and second semiconductor switches S_{R1} and S_{R2} controlled by the first and second non-overlapping rectification control signals LS_{S}, HS_{S}, respectively. The first and second rectification control signals LS_{S}, HS_{S} are generated by a self-oscillating feedback loop extending around the secondary circuit of the piezoelectric resonant power converter 100. The non-overlapping property of LS_{S}, HS_{S} forces the synchronous rectifier 123 to alternatingly connect the resonant output voltage V_{FS} to the DC output voltage V_{OUT} and ground (GND), serving as the negative DC output voltage in the present embodiment, separated by intervening dead-time periods as controlled by the timings of the first and second rectification control signals LS_{S}, HS_{S}. The skilled person will understand that the resonant output voltage V_{FS} is alternatingly connected to the DC output voltage V_{OUT} through a relatively small on-resistance of semiconductor switch S₄ and GND through a relatively small on-resistance of semiconductor switch S_{R1}. During the dead-time periods, semiconductor switches S_{R1} and S_{R2} are both placed in non-conducting states or off states to let the resonant output voltage V_{FS} essentially float such that the resonant currents flowing into, or out of, an intrinsic output inductance of the output section of the piezoelectric transformer 104 charges or discharges the input node 122 of the synchronous rectifier 123 either towards V_{OUT} or towards GND. During the dead-time period, the resonant current must charge and discharge output capacitances of the first and second semiconductor switches S_{R1} and S_{R2} and an output capacitance of the secondary section of the piezoelectric transformer 103 as these all are coupled to the input node 122 of the synchronous rectifier 123. The output capacitance associated with the secondary section of the piezoelectric transformer is normally in the range of nF while the output capacitances of typical MOSFETs used as switches S_{R1} and S_{R2} may be around hundreds of pF. Therefore, the dead time period or interval of the synchronous rectifier 123 or the input driver 103 is defined as the time interval of a switching cycle of the resonant input voltage or resonant output voltage where both semiconductor switches, e.g. MOSFETs, are in non-conducting states, i.e. turned off.

The skilled person will understand that the present invention may be applied to magnetics based resonant power converter in a corresponding manner. In such magnetics based resonant power converter, the piezoelectric transformer 104 is replaced by a resonant network typically comprising a number of interconnected capacitors and inductors in accordance with a particular converter topology. The magnetics based resonant power converter may comprise a magnetic transformer galvanically insulating the primary section and the secondary side circuitry of the resonant power converter. The magnetics based resonant power converter may for example comprise a LCC converter topology.

As previously mentioned it is important to have a sufficient duration or length of the intervening dead-time periods between the alternatingly conducting switch states of the first and second semiconductor switches S_{R1} and S_{R2} to provide optimal ZVS operation of the synchronous rectifier 123 for the reasons discussed in significant detail in the applicant's co-pending European patent application No. 15174592.4. In the latter co-pending patent application, optimal ZVS operation is discussed in the context of adjusting the corresponding dead-time periods of the semiconductor switches of the input driver 103. The ZVS operation eliminates so-called hard switching of the first and and/or second semiconductor switches S_{R1} and S_{R2} of the rectifier—Hard switching typically leads to a marked increase of the power consumption of the synchronous rectifier 123.

The secondary side circuit of the resonant power converter 100 comprises a dead-time controller comprising an ODT-s block 114 and a cooperating DB-s block 124 which jointly are configured to adaptively adjusting lengths of the dead-time periods of the synchronous rectifier 123 by controlling state switching of the first and second rectifications control signals LS_{S}, HS_{S} based on the resonant output voltage V_{FS}. The dead-time controller 114, 124 is capable of adjusting the lengths or durations of the dead-time periods by individually controlling respective timings or phases of the state transitions of the first and second rectifications control signals LS_{S}, HS_{S} applied to the control inputs of the synchronous rectifier 123. The ODT-s block 114 generates a set of control signals to the DB-s block 124 via a signal bus or connection 115. The dead-time controller exploits these control signals to provide adequate length or duration of the dead time periods of the driver circuit to deliver sufficient energy for charging and discharging the output capacitance at the output terminal or node of the output section of the piezoelectric transformer 104. This feature enables zero voltage switching (ZVS) and/or zero current switching (ZCS) of the synchronous rectifier 123 to reduce energy consumption imparted by the switching activity of the first and second semiconductor switches S_{R1} and S_{R2}.

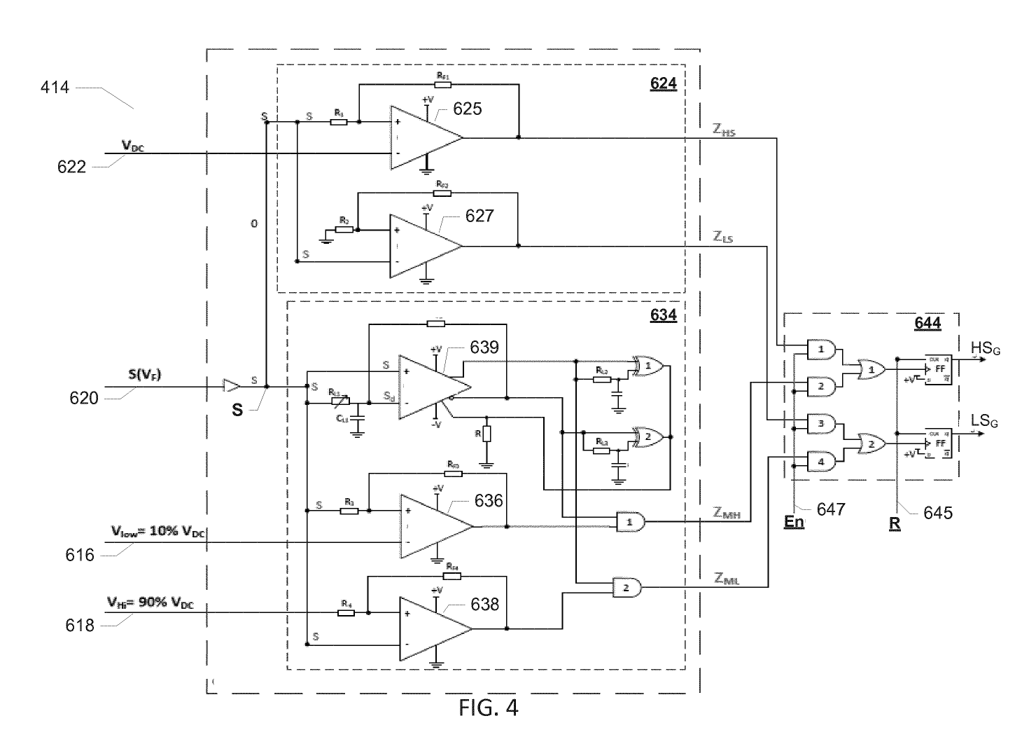

The dead-time controller 114, 124 may utilize various features of the resonant output voltage V_{FS} for detecting an optimum dead time period of each of the first and second semiconductor switches S_{R1} and S_{R2} and adaptively adjusting the dead-time period. The dead-time controller 114, 124 may in some embodiments be configured to adjust the length of the dead-time period during substantially every switching cycle of the resonant output voltage based on an instantaneous value thereof. This switching cycle is determined by a switching frequency of the resonant power converter. Alternatively, the dead-time controller may be configured to adjust the length of the dead-time period during a specific operating condition of the piezoelectric power converter 100 for example solely during a start-up phase or initialization time of the resonant network or solely during steady state operation of the resonant network as discussed in further detail below with reference to FIG. 4 illustrating an exemplary embodiment of the ODT-s block 114. The adaptive adjustment of the lengths or durations of the dead-time periods reduces energy losses and consequently leads to increased power conversion efficiency of the piezoelectric resonant power converter both during the start-up phase and during steady state operation. The self-oscillating feedback loop of the piezoelectric resonant power converter 100 extends around the secondary side circuit of the power converter. The self-oscillating feedback loop comprises a first resonant voltage or current detector 120 coupled to the output/secondary section of the piezoelectric transformer 104. The first resonant voltage or current detector 120 may be coupled to the piezoelectric transformer 104 via an auxiliary, or second secondary, electrode 121 which provides a resonant voltage or current proportional to the resonant output voltage V_{FS}. The auxiliary, or second secondary, electrode 121 may comprise a physically separate electrode structure embedded in the secondary section of the piezoelectric transformer. The output 119 of the resonant voltage or current detector 120 is digital or binary feedback signal with a frequency corresponding to, or proportional, to the resonant output voltage V_{FS}.

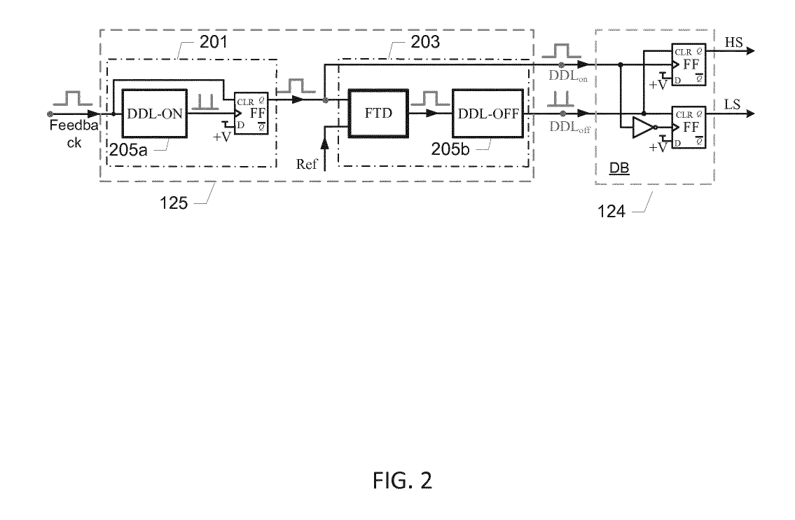

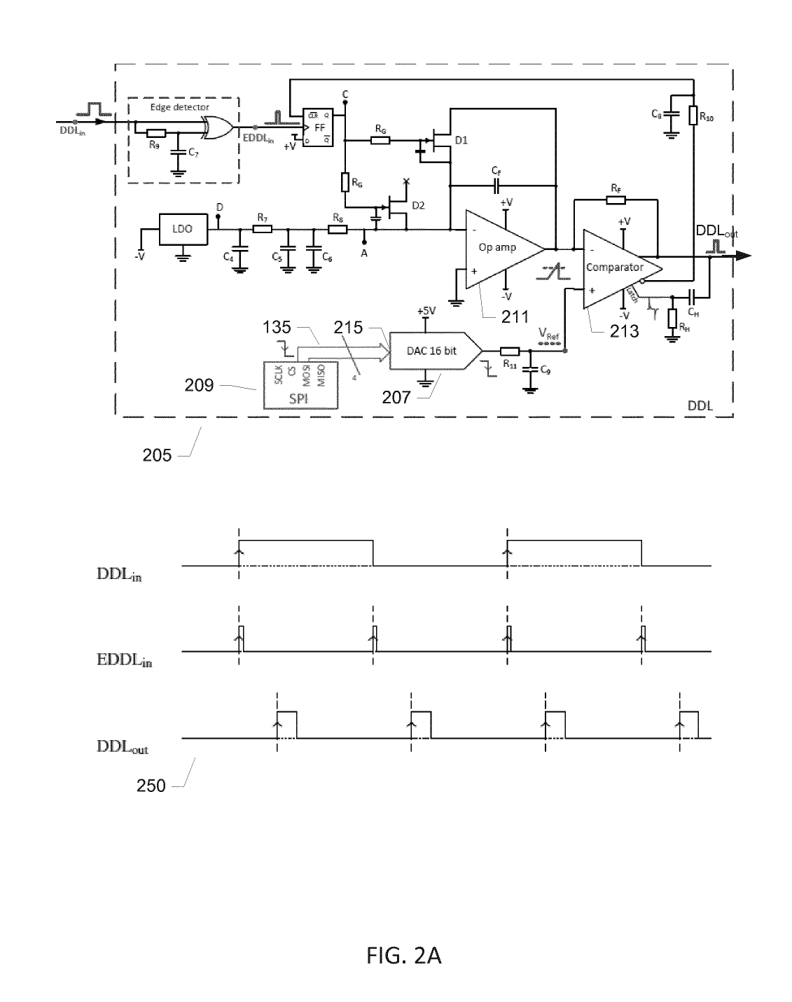

The binary feedback signal is applied to an adjustable delay circuit 125 of the self-oscillating feedback loop. The adjustable delay circuit 125 is configured for deriving the previously discussed first and second rectification control signals LS_{S}, HS_{S} of the synchronous rectifier 123 from the first feedback signal. The adjustable delay circuit 125 accomplishes this task by generating a pair of intermediate control signals ODLₒₙ and ODL_{off} for the DB-s block 124 as discussed in further detail below with reference to the exemplary embodiment of the adjustable delay circuit 125 and DB-s block 124 depicted on FIGS. 2 and 2A.

The skilled person will understand that the characteristics of the secondary side self-oscillating feedback loop discussed above must satisfy two requirements to produce sustained oscillation within the closed loop topology. One is that the phase shift through the entire feedback loop should be an integer multiple of 360°; the other requirement is that the loop gain must be greater than unity to start-up oscillation. The former condition is fulfilled by adjusting phase shift through the loop. The latter condition is preferably fulfilled by using a suitable comparator in the resonant voltage or current detector 120. The gain of this comparator can reasonably be considered infinite and therefore its output voltage, i.e. the first feedback signal, possesses a square wave shape alternatingly saturated to the positive DC supply voltage V_{DD} and the negative DC supply voltage GND.

The first and second drive control signals LS_{P}, HS_{P} of the input driver 103 are derived from the first and second rectification control signals LS_{S}, HS_{S} via the time delay or phase shift imparted by the phase shifter 126 as previously discussed. In this manner, the first and second drive control signals L_{SP}, H_{SP} may be essentially identical to the first and second rectification control signals, respectively, except for a predetermined phase shift Δϕ. In this manner, the switching frequency of the resonant input voltage V_{FP} generated by the input driver 103 is forced to, or locked to, the switching frequency of the secondary side self-oscillating feedback loop. The latter feature is advantageous in certain applications because the first and second drive control signals LS_{P}, HS_{P} are derived/generated in a relatively simple manner from the first and second rectification control signals, respectively, using a small amount of additional components and signal routing. However, this method of deriving the first and second drive control signals LS_{P}, HS_{P} may lead to sub-optimal ZVS properties of the input driver 103 in some power converter designs, because the timing of the first and second drive control signals LS_{P}, HS_{P} is based on the adaptive optimization of the first and second rectification control signals LS_{S}, HS_{S} carried out by the dead-time controller 114, 124 and the adjustable delay circuit 125. The optimum timing of the first and second drive control signals LS_{P}, HS_{P} may differ from the timing of the first and second rectification control signals LS_{S}, HS_{S} for numerous reasons for example different intrinsic input and output capacitances of the piezoelectric transformer 104 pr different intrinsic output capacitances between the pair of semiconductor switches S_{D1} and S_{D2} of the input driver and the pair of semiconductor switches S_{R1} and S_{R2} of the synchronous rectifier 123 etc.

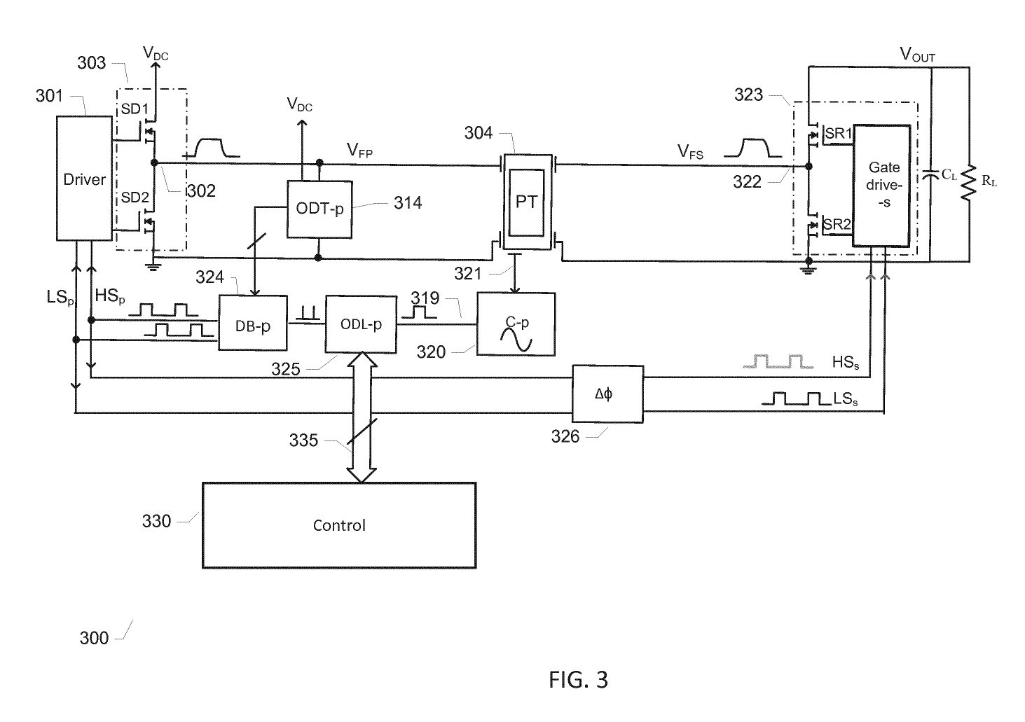

The skilled person will appreciate that the dead-time controller 114, 124 is coupled to the resonant output voltage V_{FS} in the present piezoelectric power converter 100 to derive the set of control signals, transmitted via bus 115, to the DB-s block 124 for adjusting the lengths of the dead-time periods of the synchronous rectifier 123. According to the alternative embodiment discussed below with reference to FIG. 3, a corresponding dead-time controller is coupled to the resonant input voltage V_{FP} rather than the resonant output voltage V_{FS}. In the latter embodiment, the first and second rectification control signals LS_{S}, HS_{S} are derived from the first and second drive control signals LS_{P}, HS_{P} via an optional phase shifter 326 coupled to the first and second rectification control signals LS_{S}, HS_{S} of the input driver. The use of the secondary side self-oscillating feedback loop to control the switching frequency of the present piezoelectric power converter 100 has several advantages. The closed loop control efficiently compensates for the drift or variation of component values and parameters of the power converter for example those caused by ageing and temperature variations. This is achieved because the closed loop control scheme is efficient in keeping the switching frequency of the piezoelectric power converter 100 at a proper operating point of the power converter. This switching frequency typically lies slightly above a fundamental resonant frequency of the piezoelectric transformer 104.

The adjustable delay circuit 125 of the present piezoelectric power converter 100 utilizes a digital delay line to apply a digitized phase shift compensation to the feedback signal to maintain a full feedback loop phase shift of 360° (or a multiple thereof) despite the previously discussed component and parameters variations over time. The time delay imparted by the digital delay line to the binary feedback signal (at the output 119 of the resonant voltage/current detector 120) is digitally controllable via a digital control input of the adjustable delay circuit 125 through a data communication interface 135. The data communication interface 135 is connected to a digital controller 130 that is configured to program or write a desired time delay to the adjustable delay circuit as discussed in further detail below with reference to FIG. 2A. The digital controller 130 may comprise a software programmable device such as a microprocessor or hard-wired digital logic circuitry for example comprising a digital sequential and combinational logic. The digital controller 130 may be programmed or implemented by a FPGA device or fabricated as an ASIC—for example using sub-micron CMOS technology.

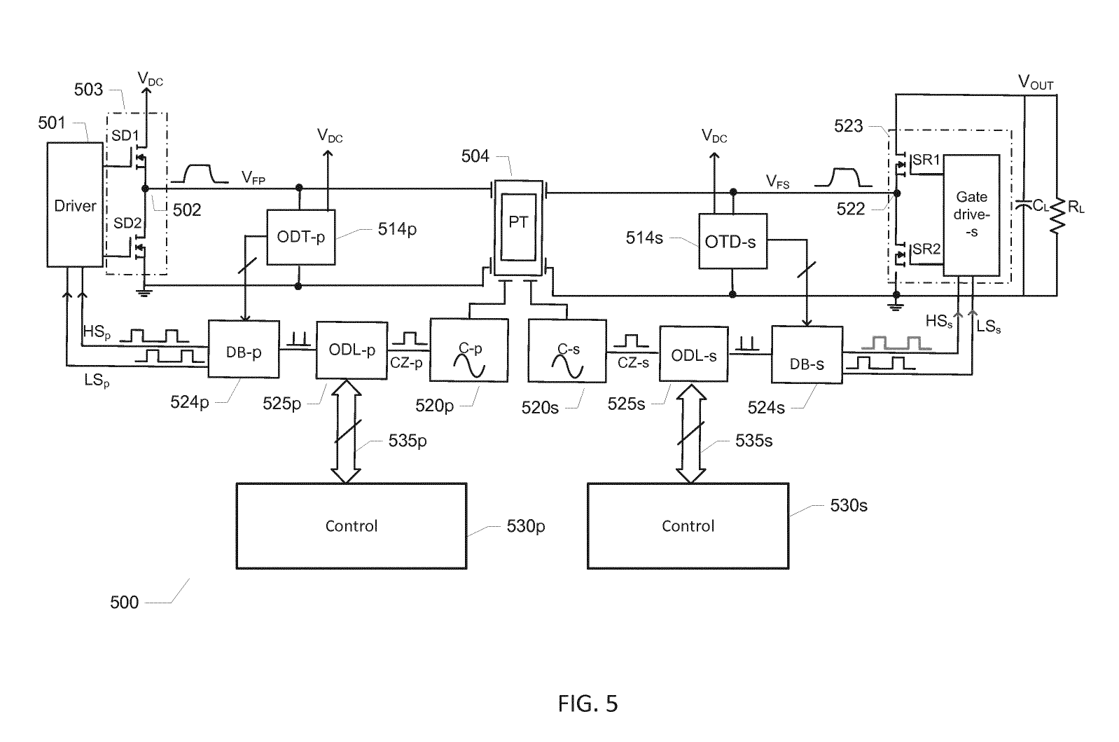

FIG. 2 shows a simplified schematic circuit diagram of an exemplary embodiment of the adjustable delay circuit 125 and the DB-s block 124 which also forms part of the dead-time controller 124 as discussed above. The skilled person will appreciate that the adjustable delay circuits of the other embodiments of the present resonant power converters 300, 500 as discussed below in connection with FIG. 3 and FIG. 5 may be substantially identical to the adjustable delay circuit 125. The ODL block 125 is composed of two sub-blocks 201, 203 designated ODLₒₙ and ODL_{off}, respectively. The previously discussed binary feedback signal is applied to the input of the adjustable delay circuit 125 and gets delayed by ODLₒₙ to turn on, i.e. switching to the conducting state, each of the first and second semiconductor switches S_{R1} and S_{R2} at its rising edge. The output of the ODLₒₙ sub-block 201 is tied to the ODL_{off} and imposes additional time delays to the binary feedback signal to turn off, i.e. switching to a non-conducting state, each of the first and second semiconductor switches S_{R1} and S_{R2} at each rising edge of its output pulses. The time delay applied by the ODL_{off} sub-block 203 defines the on-time or conducting time period of the first and second semiconductor switches S_{R1} and S_{R2}. The DB-s block 124 is controlling the final waveforms of the first and second rectification control signals LS_{S}, HS_{S}. The time delay span of the adjustable delay circuit 125 may correspond to at least one half-cycle of the either the resonant input voltage or the resonant output voltage. In the present embodiment, signal Ref applied to the input of an optional fixed time delay (FTD) circuit increases the time delay of the adjustable delay circuit 125 in certain predetermined steps to ensure that the time delay span of the circuit 125 covers at least the one half-cycle of the either the resonant input voltage or the resonant output voltage.

The configuration or topology of the adjustable delay circuit 125 provides a digitally programmable or settable time delay of the dead-time periods with very high resolution as explained in further detail below with reference to the detailed schematic of FIG. 2A. The inventors have achieved a time resolution down to 1 ns in an experimental prototype of the present piezoelectric power converter 100. The high time resolution makes it possible to accurately control the time delay added to the secondary side self-oscillating feedback loop and/or to the primary side self-oscillating feedback loop as discussed below. In return, this feature allows the digital controller 130 to very accurately adapt or adjust the switching frequency of the self-oscillating loop to changes of the operating point, e.g. the fundamental resonance frequency, of the piezoelectric transformer 104.

FIG. 2A shows a schematic circuit diagram 205 of an exemplary embodiment of the adjustable delay circuit blocks DDL-ON 205a and DDL-OFF 205b of FIG. 2 based on the digital delay line. The adjustable delay circuit block 205 comprises a resettable integrator build around operational amplifier 211 generating a saw tooth waveform to the inverting input of a comparator 213. The resettable integrator uses capacitor C_{F} as integration element and is reset by switch D1 via a control network steered by an inverting output. The non-inverting input of the comparator 213 is supplied with an adjustable reference voltage V_{Ref} generated by a programmable D/A converter 207. The programmable D/A converter 207 may have a resolution between 12 and 18 bits for example 16 bits as illustrated. The level of the reference voltage V_{Ref} is set by a digital control input 215 of the programmable D/A converter 207. This digital control input 215 is connected to the previously discussed digital controller 130 via the data communication/programming interface or bus 135. The data communication bus 135 may comprise a SPI compatible data bus or any other suitable data bus. The high resolution of the programmable D/A converter 207 enables a very small step size of the level of the reference voltage V_{Ref} such that the latter can be very accurately set to a desired voltage. The small step size of the level of the reference voltage V_{Ref} allows the delay time of the output signal DDLₒᵤₜ to in response be adjusted in very small time steps such as time steps of 10 ns or smaller or 1 ns or smaller depending inter alia on the selected resolution of the programmable D/A converter 207.

Waveform graph 250 shows respective exemplary waveforms of the input signal DDLᵢₙ and output signal DDLₒᵤₜ of the adjustable delay circuit block DDL-ON 205. The graph 250 finally shows a corresponding waveform of the internal control signal EDDLᵢₙ.

FIG. 3 shows a simplified schematic block diagram of a piezoelectric resonant power converter 300 in accordance with a second embodiment of the invention. The piezoelectric resonant power converter 300 largely comprises corresponding circuit blocks and features to those of the first embodiment of the piezoelectric resonant power converter 100 discussed above. However, the piezoelectric resonant power converter 300 comprises a self-oscillating feedback loop connected around a primary side circuit of the power converter 300 in contrast to the self-oscillating feedback loop of the previous piezoelectric resonant power converter 100 which was connected around the secondary circuit of the converter.

The primary side circuit of the resonant power converter 300 comprises a dead-time controller comprising an ODT-p block 314 and a cooperating DB-p block 324 which jointly are configured to adaptively adjusting lengths of the dead-time periods of the input driver 303 by controlling state switching of first and second driver control signals LS_{P}, HS_{P} based on the resonant output voltage V_{FS}. The dead-time controller 314, 324 is thereby capable of adjusting the lengths or durations of the dead-time periods of input driver 303 by individually controlling timing or phase of the state transitions of the first and second driver control signals L_{SP}, HS_{P} applied to the control inputs of the input driver. The input driver 303 comprises semiconductor switches S_{D1} and S_{D2} which are both placed in non-conducting states, or off states, during each dead-time period to let the resonant input voltage V_{FP} essentially float such that resonant currents flowing into, or out of, an intrinsic input inductance of the primary section of the piezoelectric transformer 304 charges or discharges the resonant input voltage V_{FP} either towards V_{DC} or towards GND. During each the dead-time period, the resonant current must either charge or discharge the output capacitances of the first and second semiconductor switches SDI and S_{D2} and an input capacitance of the primary section of the piezoelectric transformer 303 as these all are coupled to the deriver output node 102. The role of the ODT-p block 314 and cooperating DB-p block 324 is to provide an adaptable and optimum length of the dead-time periods of the input driver 303 in a manner largely similar to the adaptable and optimum dead-time period of the synchronous rectifier 123 of the previous embodiment of the resonant power converter 100. As mentioned previously, the operation theory and principles of the dead-time controllers are discussed in significant detail in the applicant's co-pending European patent application No. 15174592.4. FIG. 4 is illustrating an exemplary embodiment of the ODT-p block 314.

The primary side self-oscillating feedback loop comprises a resonant voltage or current detector 320 coupled to the input/primary section of the piezoelectric transformer 304. The first resonant voltage or current detector 320 may be coupled to the piezoelectric transformer 304 via an auxiliary, or second primary, electrode 321 which provides a resonant voltage or current proportional to the resonant input voltage V_{FP}. The output 319 of the resonant voltage or current detector 320 is digital or binary feedback signal with a frequency corresponding to, or proportional, to the resonant output voltage V_{FP}. The binary feedback signal is applied to an adjustable delay circuit 325 of the primary side self-oscillating feedback loop. The adjustable delay circuit 125 derives the previously discussed first and second drive control signals LS_{P}, HS_{P} from the binary feedback signal in a similar manner to the operation of the previously discussed adjustable delay circuit 125 of the first embodiment of the power converter 100. The skilled person will understand that the characteristics of the primary side self-oscillating feedback loop must satisfy same two requirements as those discussed above in respect of the secondary side self-oscillating feedback loop discussed above to produce and maintain sustained oscillation in the closed loop. The resonant power converter 300 furthermore comprises a digital controller 330 that is configured to program or write a desired time delay to the adjustable delay circuit 325 via a data bus or interface 335 in a similar manner to the one discussed above in connection with the previous embodiment of the invention.

The first and second rectification control signals LS_{S}, HS_{S} of the synchronous rectifier 323 of the secondary side circuit are derived from the first and second drive control signals LS_{P}, HS_{P} of the input driver 303 via a time delay or phase shift imparted by a phase shifter 326. In this manner, the first and second rectification control signals LS_{S}, HS_{S} are derived by the primary side connected dead-time controller 325 which is coupled to the resonant input voltage V_{FP} rather than the resonant output voltage V_{FS}. The first and second rectification control signals may be essentially identical to the first and second drive control signals, respectively, except for a predetermined phase shift Δϕ generated by the phase shifter 326. Thereby, the switching frequency of the resonant output voltage V_{FS} applied to the input of the synchronous rectifier 323 is forced to, or locked to, the switching frequency of the primary side self-oscillating feedback loop. The latter feature is advantageous in certain applications because the first and second rectification control signals LS_{S}, HS_{S} are derived/generated in a relatively simple manner from the first and second drive control signals, respectively, using a small amount of additional components and signal routing. The role of the primary side self-oscillating feedback loop of the present converter 300 is to control the switching frequency of the piezoelectric power converter 300 and preferably maintain the switching frequency of the converter at a substantially optimal frequency of the piezoelectric transformer 304 despite drift and variation of component values and parameters of the power converter 300—for example caused by ageing and/or temperature variations.

FIG. 4 shows a schematic block diagram of an exemplary embodiment of the dead-time controllers 114, 314, 514 of the piezoelectric power converters 100, 300, 500. The dead-time controller 414 comprises inter alia a steady-state controller 624 and a start-up controller 634 and a control circuit 644 (OTD C). The steady-state controller 624 is adapted to generate appropriately timed first and second driver control signals HS_{G}, LS_{G} for the either the input driver 103 or the synchronous rectifier 323 of the piezoelectric power converters 100, 300. The start-up controller 634 is adapted to generate appropriately timed first and second driver control signals HS_{G}, LS_{G} or first and second rectification control signals LS_{S}, HS_{S} during the initialization time or start-up time of the piezoelectric power converters 100, 300. The operation theory and operation principles of the dead-time controller 514 are discussed in significant detail in the applicant's co-pending European patent application No. 15174592.4 and will not be repeated here.

FIG. 5 is a simplified schematic circuit diagram of a piezoelectric resonant power converter 500 in accordance with a third embodiment of the invention. The piezoelectric resonant power converter 500 comprises two separately operating self-feedback loops connected around the primary section of the converter and the secondary section of the converter, respectively, to induce independent self-oscillations around the primary section and the secondary section of the converter. The piezoelectric resonant power converter 500 furthermore comprises two separate dead-time controllers. A first dead-time controller is connected to the resonant output voltage and comprises an ODT-s block 514 and a cooperating DB-s block 524 which jointly are configured to adaptively adjusting lengths of the dead-time periods of the synchronous rectifier 523 by controlling state switching of first and second driver control signals LS_{P}, HS_{P} based on the resonant output voltage V_{FS}. The primary side circuit of the resonant power converter 500 comprises a second dead-time controller comprising an ODT-p block 514 and a cooperating DB-p block 524p which jointly are configured to adaptively adjusting lengths of the dead-time periods of the input driver 503 by controlling state switching of first and second driver control signals LS_{P}, HS_{P} based on the resonant input voltage V_{FP}. The skilled person will understand that the first dead-time controller may be substantially identical to the dead-time controller discussed above in connection with the first embodiment of the piezoelectric power converter 100 and that the second dead-time controller may be substantially identical to the dead-time controller discussed above in connection with the second embodiment of the piezoelectric power converter 300. The use of two separate dead-time controllers in the present piezoelectric resonant power converter 500 provides separate optimization of the lengths of the dead-time periods of synchronous rectifier 523 and the lengths of the dead-time periods of the input driver 503. This may be a significant advantage for numerous types of resonant power converters because the optimum lengths of these different dead-time periods typically differ for example due to different intrinsic input and output capacitances of the piezoelectric transformer 504 etc. as briefly discussed above.

The first self-oscillating feedback loop of the piezoelectric resonant power converter 500 comprises a first resonant voltage or current detector 520s coupled to an output/secondary section of the piezoelectric transformer 504. The first resonant voltage or current detector 520s may be coupled to the piezoelectric transformer 504 via an auxiliary, or second secondary, electrode as discussed above in connection with FIG. 1. The output of the resonant voltage or current detector 520s is a digital or binary feedback signal with a frequency corresponding to, or proportional, to the resonant output voltage V_{FS}. The binary feedback signal is applied to a first adjustable delay circuit 525s of the self-oscillating feedback loop which may be identical to the previously discussed adjustable delay circuit 125 of the first power converter embodiment 100. The second, or primary side, self-oscillating feedback loop comprises a second resonant voltage or current detector 520p coupled to the input/primary section of the piezoelectric transformer 504. The second resonant voltage or current detector 520p may be coupled to the piezoelectric transformer 504 via an auxiliary, or second primary, electrode as discussed above in connection with FIG. 3. The output of the resonant voltage or current detector 520p is a digital or binary feedback signal with a frequency corresponding to, or proportional, to the resonant input voltage V_{FP}. The binary feedback signal is applied to a second adjustable delay circuit 525p of the primary side self-oscillating feedback loop. The second adjustable delay circuit 525p derives the previously discussed first and second drive control signals LS_{P}, HS_{P} from the binary feedback signal in a similar manner to the operation of the previously discussed adjustable delay circuit 325 of the second embodiment of the power converter 300. The skilled person will understand operational characteristics and features of the first self-oscillating feedback loop may be substantially identical to those of the self-oscillating feedback loop discussed above in connection with the first embodiment of the piezoelectric power converter 100 and that the operational characteristics and features of the second self-oscillating feedback loop may be substantially identical to those of the self-oscillating feedback loop discussed above in connection with the second embodiment of the piezoelectric power converter 300.

The presence of two separate self-oscillating feedback loops within the present piezoelectric resonant power converter 500 provides numerous advantages such as an adjustable bi-directional power flow between the DC input voltage and the DC output voltage. This bi-directional power flow can furthermore be very accurately and flexibly controlled by the digital control, via the digital controller 530s, of the time delay through programming of the first adjustable delay circuit 525s, e.g. with 10 ns or better resolution such as better than 1 ns. The control of the bi-directional power flow is a significant advantage because this feature allows efficient driving of inductive loads and seamless integration in numerous smart-grid applications and networks. The piezoelectric resonant power converter 500 furthermore comprises first and second digital controllers 530s, 530p. The first digital controller 530s is configured to program or write a desired time delay to the first adjustable delay circuit 525s via a first data bus or interface 535s in a similar manner to the one discussed above in connection with FIG. 1. The second digital controller 530p is configured to program or write a desired time delay to the first adjustable delay circuit 525s via a second data bus or interface 535p in a similar manner to the one discussed above in connection with FIG. 3. The first and second digital controllers 530p, 530s may be physically separate circuits or devices which has the advantage of enabling galvanic isolation between the primary side and secondary side circuits of the piezoelectric resonant power converter 500. However, in alternative embodiments of power converter 500, the first and second digital controller 530p, 530s may be integrated or fused to form a single physical circuit or device connected to both of the first and second data busses or interfaces 535s, 535p. This embodiment of the power converter 500 may lower component costs and space requirements of the power converter.

1. A resonant power converter comprising:
a first power supply rail for receipt of a positive DC supply voltage and a second power supply rail for receipt of a negative DC supply voltage,
a resonant network comprising an input section for receipt of a resonant input voltage and an output section for supplying a resonant output voltage generated in response to the resonant input voltage,
an input driver configured for supplying the resonant input voltage;
a synchronous rectifier comprising:
a rectifier input coupled to the resonant output voltage,
first and second semiconductor switches controlled by first and second rectification control signals, wherein the synchronous rectifier is configured for alternatingly connecting the resonant output voltage to positive and negative DC output nodes via the first and second semiconductor switches, respectively, separated by intervening dead-time periods in accordance with the first and second rectification control signals;
a first dead-time controller coupled to the resonant output voltage or to the resonant input voltage and configured for adaptively adjusting lengths of the dead-time periods via the first and second rectification control signals.

2. A resonant power converter according to claim 1, wherein the input driver comprises third and fourth semiconductor switches controlled by first and second driver control signals; wherein the input driver is configured for alternatingly connecting the resonant input voltage to the positive and negative DC supply voltages through the third and fourth semiconductor switches, respectively, separated by intervening dead-time periods in accordance with the first and second driver control signals.

3. A resonant power converter according to claim 1, wherein the resonant network comprises a piezoelectric transformer;
wherein the input section of the resonant network comprises a primary section of the piezoelectric transformer coupled to the resonant input voltage and the output section of the resonant network comprises a secondary section of the piezoelectric transformer for generating the resonant output voltage.

4. A resonant power converter according to claim 1, wherein the first and second rectification control signals are derived from:
the resonant output voltage or a resonant output current of the output section of the resonant circuit.

5. A resonant power converter according to claim 1, wherein the first and second driver control signals of the input driver are derived from the resonant input voltage or a resonant input current of the input section of the resonant circuit.

6. A resonant power converter according to claim 4, wherein the first dead-time controller is coupled to the resonant output voltage; said resonant power converter further comprising:
a first self-oscillating feedback loop comprising:
a first resonant voltage or current detector coupled to the output section of the resonant circuit and configured to derive a first feedback signal from the resonant output voltage or the resonant output current of the output section; and
a first adjustable delay circuit configured for generating the first and second rectification control signals based on the first feedback signal.

7. A resonant power converter according to claim 3, wherein the piezoelectric transformer comprises:
a first secondary electrode connected to the secondary section of the piezoelectric transformer for supplying the resonant output voltage; and
a second secondary electrode embedded in the secondary section of the piezoelectric transformer for supplying the first feedback signal to the first adjustable delay circuit.

8. A resonant power converter according to claim 3, wherein the piezoelectric transformer comprises:
a first primary electrode connected to the primary section of the piezoelectric transformer for supplying the resonant input voltage or resonant input current; and
a second primary electrode embedded in the primary section of the piezoelectric transformer for supplying the first feedback signal to the first adjustable delay circuit.

9. A resonant power converter according to claim 6, further comprising:
a second self-oscillating feedback loop comprising:
a second resonant voltage or resonant current detector coupled to the input section of the resonant circuit and configured to derive a second feedback signal from the resonant input voltage or resonant input current; and
a second adjustable delay circuit configured for generating the first and second drive control signals based on the second feedback signal; and
a second dead-time controller coupled to the resonant input voltage or input current and configured for adaptively adjusting lengths of the dead-time periods of the input driver via the first and second driver control signals.

10. A resonant power converter according to claim 6, wherein the first adjustable delay circuit comprises a first digital delay line and a first digital control input for adjusting respective time delays between the first feedback signal and the first and second rectification control signals; or
the second adjustable time delay circuit comprises a second digital delay line and a second digital control input for adjusting respective time delays between the second feedback signal and the first and second driver control signals.

11. A resonant power converter according to claim 10, further comprising:
a digital processor comprising a first data communication interface connected to at least one of the first and second digital control inputs of the first and second adjustable time delay circuits;
said digital processor being configured to repeatedly compute and apply time delay settings for at least one of:
the first digital delay line for adapting a switching frequency of the first self-oscillating feedback loop to a fundamental resonance frequency of the output section of the resonant circuit; and
the second digital delay line for adapting a switching frequency of the second self-oscillating feedback loop to a fundamental resonance frequency of the input section of the resonant circuit.

12. A resonant power converter according to claim 11, wherein the digital processor is configured to:
compute the time delay settings of the first digital delay line to maintain a loop phase shift of substantially 360 degrees, or an integer multiple of 360 degrees, in the first self-oscillating feedback loop; or
compute the time delay settings of the second digital delay line to maintain a loop phase shift of substantially 360 degrees, or an integer multiple of 360 degrees, in the second self-oscillating feedback loop.

13. A method of adaptively controlling dead-time periods of a synchronous rectifier of a resonant power converter, said method comprising steps of:
a) deriving first and second non-overlapping rectification control signals of the synchronous rectifier from a resonant output voltage or from a resonant input voltage of a resonant network of the resonant power converter, wherein the synchronous rectifier is coupled between positive and negative DC output voltage nodes of the resonant power converter,
b) applying the first and second non-overlapping rectification control signals to control inputs of the synchronous rectifier to generate a DC output voltage by alternatingly connecting the resonant output voltage to the positive and negative DC output voltage nodes separated by intervening dead-time periods,
c) monitoring at least one of the resonant output voltage and the resonant input voltage,
d) detecting a feature or characteristic of a waveform of the resonant output voltage or of the resonant input voltage,
f) adjusting lengths of the dead-time periods of the synchronous rectifier based on the detected feature.

14. A method of adaptively controlling dead-time periods of a synchronous rectifier according to claim 13, wherein step d) comprises:
detecting the feature of the waveform during each cycle of the resonant input voltage waveform or detecting the feature of the waveform during each cycle of the resonant output voltage waveform.

15. A resonant power converter according to claim 5, wherein the first dead-time controller is coupled to the resonant output voltage; said resonant power converter further comprising:
a first self-oscillating feedback loop comprising:
a first resonant voltage or current detector coupled to the output section of the resonant circuit and configured to derive a first feedback signal from the resonant output voltage or the resonant output current of the output section; and
a first adjustable delay circuit configured for generating the first and second rectification control signals based on the first feedback signal.

16. A resonant power converter according to claim 4, wherein the piezoelectric transformer comprises:
a first secondary electrode connected to the secondary section of the piezoelectric transformer for supplying the resonant output voltage; and
a second secondary electrode embedded in the secondary section of the piezoelectric transformer for supplying the first feedback signal to the first adjustable delay circuit.

17. A resonant power converter according to claim 5, wherein the piezoelectric transformer comprises:
a first secondary electrode connected to the secondary section of the piezoelectric transformer for supplying the resonant output voltage; and
a second secondary electrode embedded in the secondary section of the piezoelectric transformer for supplying the first feedback signal to the first adjustable delay circuit.

18. A resonant power converter according to claim 6, wherein the piezoelectric transformer comprises:
a first secondary electrode connected to the secondary section of the piezoelectric transformer for supplying the resonant output voltage; and
a second secondary electrode embedded in the secondary section of the piezoelectric transformer for supplying the first feedback signal to the first adjustable delay circuit.

19. A resonant power converter according to claim 7, further comprising:
a second self-oscillating feedback loop comprising:
a second resonant voltage or resonant current detector coupled to the input section of the resonant circuit and configured to derive a second feedback signal from the resonant input voltage or resonant input current; and
a second adjustable delay circuit configured for generating the first and second drive control signals based on the second feedback signal; and
a second dead-time controller coupled to the resonant input voltage or input current and configured for adaptively adjusting lengths of the dead-time periods of the input driver via the first and second driver control signals.

20. A resonant power converter according to claim 8, further comprising:
a second self-oscillating feedback loop comprising:
a second resonant voltage or resonant current detector coupled to the input section of the resonant circuit and configured to derive a second feedback signal from the resonant input voltage or resonant input current; and
a second adjustable delay circuit configured for generating the first and second drive control signals based on the second feedback signal; and
a second dead-time controller coupled to the resonant input voltage or input current and configured for adaptively adjusting lengths of the dead-time periods of the input driver via the first and second driver control signals.
